(19) United States
(12) Patent Application Publication
(10) Pub. No.: US 2024/0210943 A1
(43) Pub. Date: Jun. 27, 2024

(54) DRIVING APPARATUS AND OPERATING METHOD THEREOF

(71) Applicant: SEMES CO., LTD., Cheonan-si (KR)

(72) Inventors: Seung Chan LEE, Cheonan-si (KR); Ho Young LEE, Cheonan-si (KR); Wang Hyeon SON, Cheonan-si (KR); Woo Sang KWON, Cheonan-si (KR)

(73) Assignee: SEMES CO., LTD., Cheonan-si (KR)

(21) Appl. No.: 18/483,970

(22) Filed: Oct. 10, 2023

(30) Foreign Application Priority Data
Dec. 26, 2022 (KR) 10-2022-0183900

(51) Int. Cl. G05D 1/02

(52) U.S. Cl. CPC G05D 1/0212; G05D 1/0234; G05D 2201/0206

(57) ABSTRACT

A driving apparatus and an operating method of the same are provided. The driving apparatus includes: a driving part for driving; and a handling part positioned above the driving part and handling a target object, wherein the handling part transports the target object to a destination and performs a self-replacement operation of replacing the target object with a replacement target object located at the destination.

### CROSS-REFERENCE TO RELATED APPLICATION

This application claims priority from Korean Patent Application No. 10-2022-0183900 filed on Dec. 26, 2022 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a driving apparatus and an operating method thereof.

### 2. Description of the Related Art

With the advancement of robotics technology, autonomous driving-based transportation is being carried out. Autonomous driving robots operate on various driving paths. The autonomous driving robots are designed to handle various objects within their line of path, such as substrates, probe cards, etc. Efficient operations for the autonomous driving robots are essential for loading, transporting, and returning such objects.

### SUMMARY

Aspects of the present disclosure provide addressing problems such as reduced operational efficiency and productivity that may arise when a single driving apparatus is provided to handle target objects.

Aspects of the present disclosure also provide overcoming the constraint of limited practical utility due to the high cost of driving apparatuses when multiple driving apparatuses are provided to handle target objects.

Aspects of the present disclosure also provide preventing issues such as reduced working comfort and various physical collisions that may arise due to the congested arrangement of driving apparatuses within the space where the handling of target object handling actually takes place.

Aspects of the present disclosure also provide a solution that allows autonomous deployment, loading, and transport even with a single driving apparatus, thereby resolving the problems associated with both the use of a single driving apparatus and the use of multiple driving apparatuses.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, a driving apparatus includes: a driving part for driving; and a handling part positioned above the driving part and handling a target object, wherein the handling part transports the target object to a destination and performs a self-replacement operation of replacing the target object with a replacement target object located at the destination.

According to another aspect of the present disclosure, a driving apparatus includes: a driving part for driving; and a handling part positioned above the driving part and handling a target object, wherein the handling part transports the target object to a destination and performs a self-replacement operation of replacing the target object with a replacement target object located at the destination, the handling part includes a base unit and a pickup unit, which interlocks with the base unit and performs a first pickup operation of picking up the target object and a second pickup operation of picking up the replacement target object, the handling part further includes an acquisition unit, which interlocks with the base unit and performs a first acquisition operation of acquiring the target object based on the first pickup operation and a second acquisition operation of acquiring the replacement target object based on the second pickup operation, and if the target object corresponds to a probe card, the destination corresponds to a probe station.

According to another aspect of the present disclosure, an operating method of a driving apparatus includes: preparing a driving part for driving; and handling, by a handling part, a target object based on the driving of the driving part, wherein the handling part transports the target object to a destination and performs a self-replacement operation of replacing the target object with a replacement target object located at the destination.

According to the aforementioned and other embodiments of the present disclosure, it is possible to address problems such as reduced operational efficiency and productivity that may arise when a single driving apparatus is provided to handle target objects.

Additionally, it is possible to overcome the constraint of limited practical utility due to the high cost of driving apparatuses when multiple driving apparatuses are provided to handle target objects.

Moreover, it is possible to prevent issues such as reduced working comfort and various physical collisions that may arise due to the congested arrangement of driving apparatuses within the space where the handling of target object handling actually takes place.

Furthermore, it is possible to provide a solution that allows autonomous deployment, loading, and transport even with a single driving apparatus, and thus to resolve the problems associated with both the use of a single driving apparatus and the use of multiple driving apparatuses.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram of a driving apparatus according to an embodiment of the present disclosure;

FIG. 2 is a detailed block diagram of the driving apparatus of FIG. 1;

FIG. 3 is a detailed block diagram of the driving apparatus of FIG. 2;

FIGS. 4 and 5 are schematic views illustrating the driving apparatus of FIG. 1;

FIG. 6 is a diagram illustrating a configuration for performing an up-down inversion operation of the driving apparatus of FIG. 1;

FIGS. 7 through 14 are schematic views illustrating sequential steps of the operation of the driving apparatus of FIG. 1; and

FIG. 15 is a flowchart illustrating an operating method of a driving apparatus according to an embodiment of the present disclosure.

### DETAILED DESCRIPTION

Preferred embodiments of the present disclosure will be described in detail with reference to the accompanying drawings. The present disclosure and methods of accomplishing the same may be understood more readily by reference to the following detailed description of embodiments and the accompanying drawings. However, the present disclosure may be embodied in many different forms, and should not be construed as being limited to the embodiments set forth herein. Rather, these embodiments are provided so that this disclosure will be through and complete and will fully convey the concept of the invention to those skilled in the art, and the present disclosure will only be defined by the appended claims. Like reference numbers designate like elements throughout the specification.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented, and, as such, the spatially relative descriptors used herein interpreted accordingly.

It will be understood that, although the terms “first”, “second”, etc. may be used herein to describe various elements, constituent elements and/or sections, the elements, constituent elements and/or sections should not be limited by these terms. These terms are only used to distinguish one element, constituent element, or section from another element, constituent element, or section. Thus, a first element, a first constituent element, or a first section discussed below should be termed a second element, a second constituent element, or a second section.

As used herein, the singular forms “a,” “an,” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

Exemplary embodiments of the present disclosure will hereinafter be described with reference to the accompanying drawings. Like reference numerals indicate like elements through the specification, and thus, detailed descriptions thereof will be omitted.

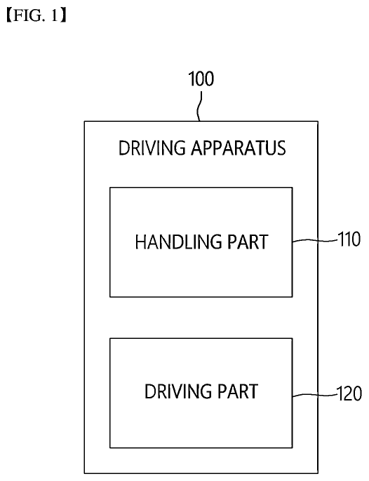

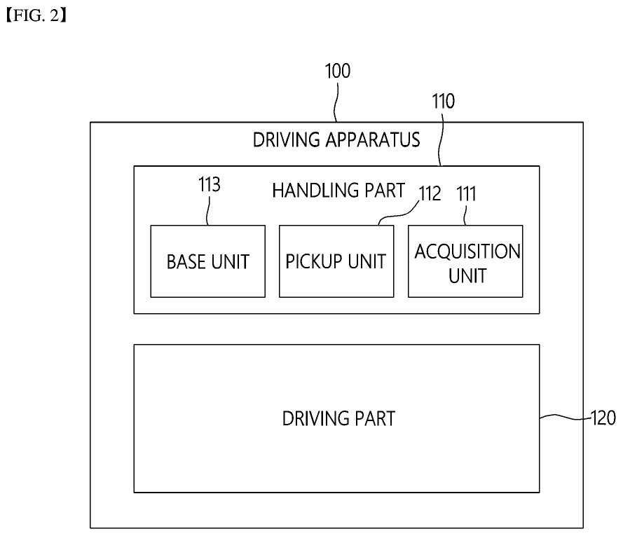

Referring to FIG. 1, a driving apparatus 100 may include a handling part 110 and a driving part 120. Referring to FIG. 2, the handling part 110 includes an acquisition unit 111, a pickup unit 112, and a base unit 113.

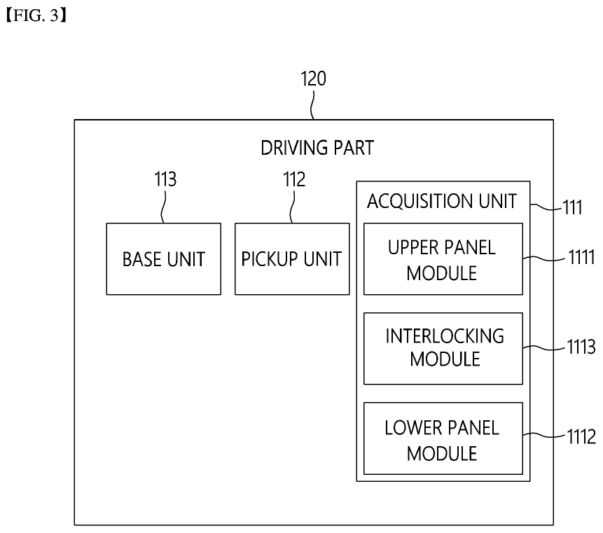

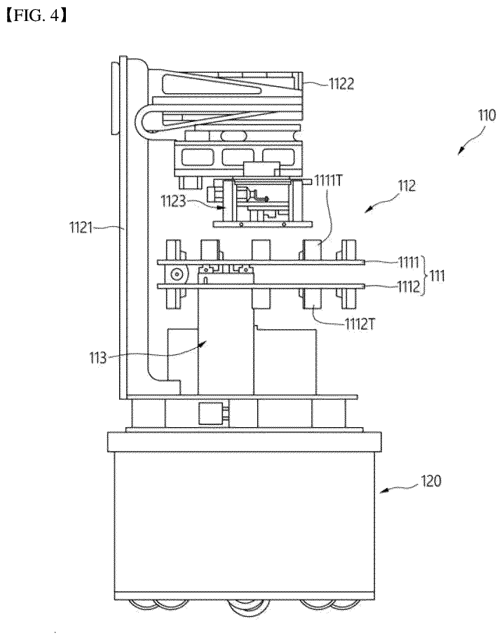

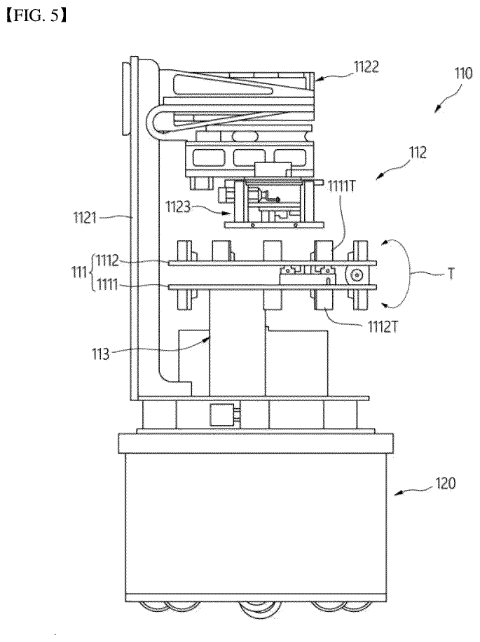

Referring to FIG. 3, the acquisition unit 111 includes an upper panel module 1111, a lower panel module 1112, and an interlocking module 1113. Referring to FIGS. 4 and 5, the driving part 120 of the driving apparatus 100 performs functions such as autonomous driving and obstacle recognition on the driving path.

The handling part 110 of the driving apparatus 100 is positioned above the driving part 120 and handles a target object 10. The handling part 110 transports the target object 10 to a destination E.

Furthermore, the handling part 110 performs a self-replacement operation of replacing the target object 10 with a replacement target object 20 located at the destination E. The base unit 113 of the handling part 110 corresponds to a foundational structure.

The pickup unit 112 of the handling part 110 interlocks with the base unit 113. The pickup unit 112 performs a first pickup operation of picking up the target object 10 and a second pickup operation of picking up the replacement target object 20.

Here, the handling part 110 interlocks with the base unit 113. The handling part 110 performs a first acquisition operation of acquiring the target object 10 based on the first pickup operation and a second acquisition operation of acquiring the replacement target object 20 based on the second pickup operation.

The acquisition unit 111 is positioned such that at least a portion of the acquisition unit 111 faces the pickup unit 112. The acquisition unit 111 performs the first acquisition operation for the target object 10 and the second pickup operation for the replacement target object 20.

Moreover, the acquisition unit 111 is relayed from the first acquisition operation to the second acquisition operation based on a vertical inversion operation. The upper panel module 1111 of the acquisition unit 111 is a place where the target object 10 resides.

The lower panel module 1112 of the acquisition unit 111 interlocks with the upper panel module 1111 and is a place where the replacement target object 20 resides. The interlocking module 1113 of the acquisition unit 111 enables the upper panel module 1111 to interlock with the lower panel module 1113.

Meanwhile, the first pickup operation of the pickup unit 112 is performed first, and then the second acquisition operation of the upper panel module 1111 is performed based on the first pickup operation.

Thereafter, the driving part 120 departs to the destination E, and then the second acquisition operation of the lower panel module 1113 is performed based on the second pickup operation.

The vertical inversion operation of the handling part 110 may include first and second vertical inversion operations. The first vertical inversion operation may take place at a first point in time before the departure of the driving part 120 to the destination E.

For example, the upper panel module 1111, where the target object 10 is chucked, may replace the lower panel module 1113 via a rotation method.

The second vertical inversion operation may take place at a second point in time after the arrival of the driving part 120 at the destination E. The second vertical inversion operation replaces the upper panel module 1111, where the target object 10 is chucked, with the lower panel module 1113.

Additionally, the pickup unit 112 positions the replacement target object 20 on the lower panel module 1113 that has been subjected to the first vertical inversion operation, via the second pickup operation.

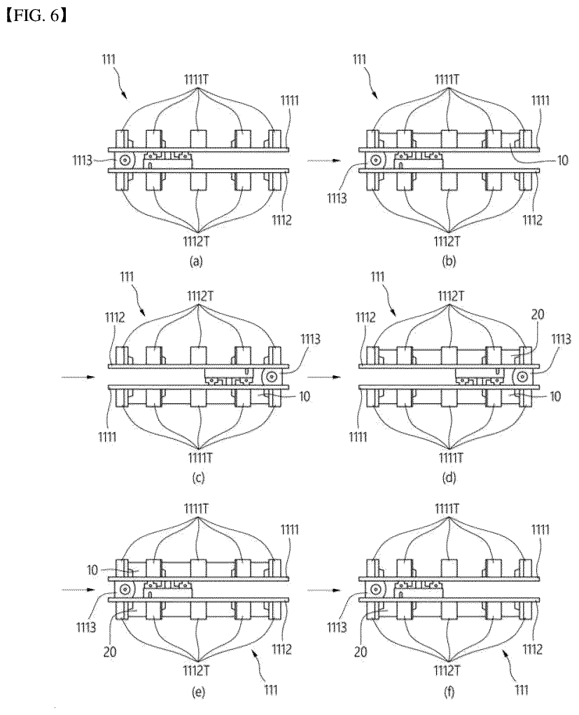

Referring to FIGS. 4 through 6, a plurality of first fixing members 1111T are provided along the circumference of an upper part of the upper panel module 1111, fixing the target object 10 located on the upper panel module 1111.

A plurality of second fixing members 1112T are provided along the circumference of a lower part of the lower panel module 1112, fixing the replacement target object 20 located on the lower panel module 1112.

The first fixing members 1111T may grasp the target object 10 on the upper panel module 1111 using a joint rotation method or may press and secure the circumference of the target object 10 by slidably moving on the upper panel module 1111.

Similarly, the second fixing members 1112T may grasp the replacement target object 20 on the lower panel module 1112 using the joint rotation method or may press and secure the circumference of the replacement target object 20 by slidably moving on the lower panel module 1113.

The acquisition unit 111 displaces the upper panel module 1111 to take the position of the lower panel module 1113 via the second vertical inversion operation after the first vertical inversion operation.

The pickup unit 112 performs a third pickup operation of picking up the target object 10 located on the upper panel module 1111 and positioning the target object 10 at the destination E. The target object 10 is chucked onto the upper panel module 1111, and the replacement target object 20 is chucked onto the lower panel module 1113.

Meanwhile, if the target object 10 corresponds to, for example, a probe card, the destination E may correspond to a probe station. The driving part 120 of the driving apparatus 100 performs autonomous driving for an unmanned process within a cleanroom line.

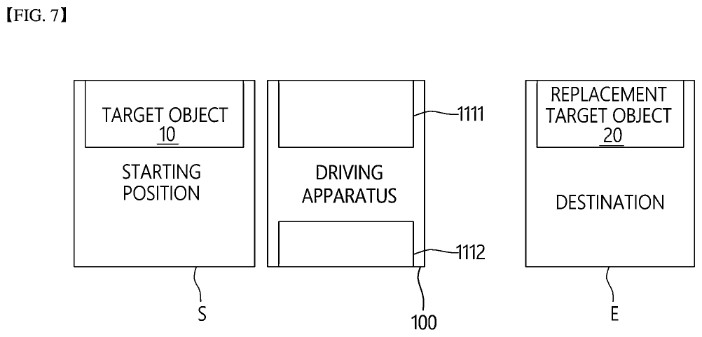

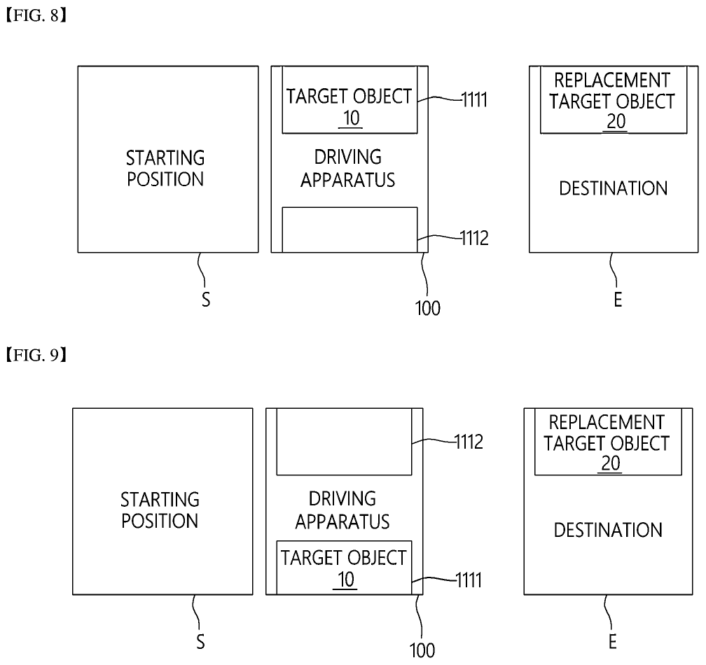

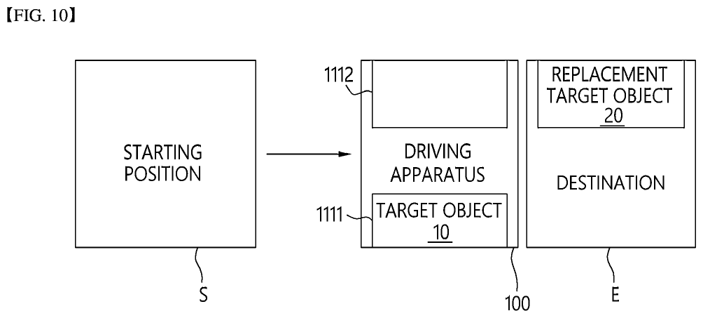

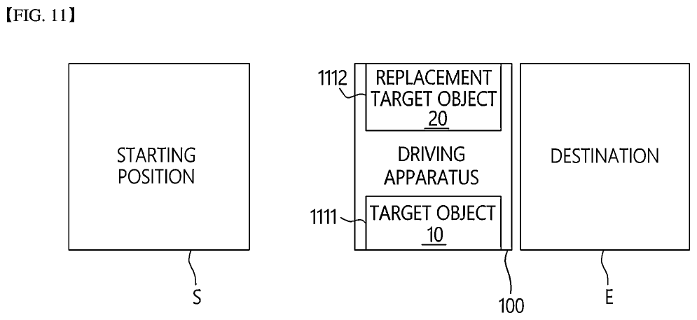

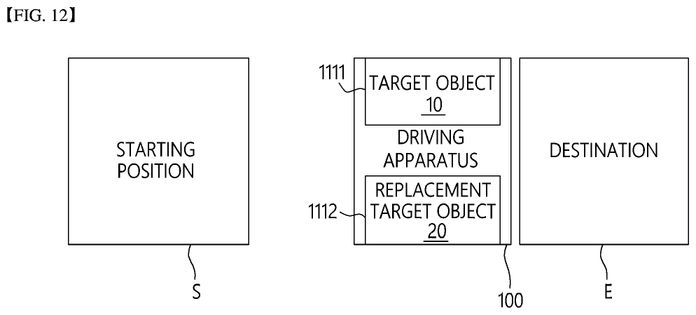

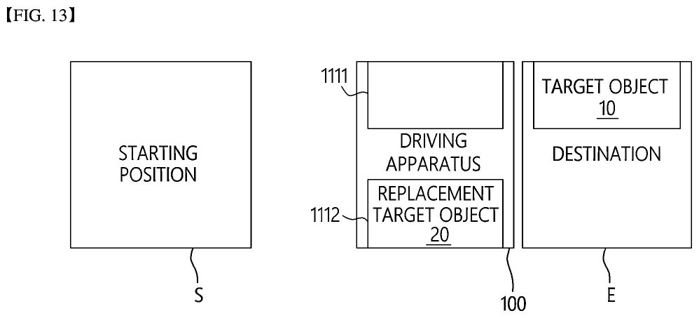

Referring to FIGS. 7 through 14, the driving apparatus 100 is positioned to acquire the target object 10 from a starting position S. The driving apparatus 100 acquires the target object 10, initially positions the target object 10 at its top, and repositions the target object 10 at its bottom via the vertical inversion operation.

Furthermore, the driving apparatus 100 travels to the destination E where the replacement target object 20 is situated. The driving apparatus 100 acquires the replacement target object 20 and positions the replacement target object 20 at its top. That is, the target object 10 is positioned at the bottom of the driving apparatus 100, while the replacement target object 20 is positioned at the top of the driving apparatus 100.

Here, the driving apparatus 100 enables the vertical inversion operation between the target object 10 and the replacement target object 20. Additionally, the driving apparatus 100 loads the target object 10 located at its top onto the destination E.

As mentioned earlier, the destination E may be, for example, a probe card station, and the target object 10 and the replacement target object 20 may both be, for example, probe cards.

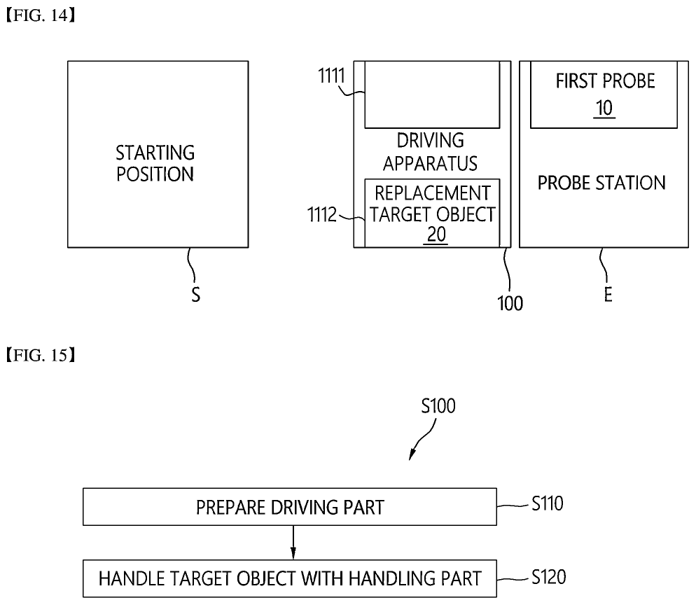

Referring to FIG. 15, an operational method S100 of the driving apparatus 100 includes: preparing the driving part 120 for driving. The handling part 110 handles the target object 10 in accordance with the movement of the driving part 120.

Here, the handling of the target object 10 involves tasks such as transferring, loading, and unloading the target object 10. The handling part 110 transports the target object 10 to the destination E and performs a self-replacement operation of replacing the replacement target object 20 at the destination E with the target object 10.

The pickup unit 112 of the handling part 110 interlocks with the base unit 113 and is for performing the first pickup operation of picking up the target object 10 and the second pickup operation of picking up the replacement target object 20.

Also, the handling part 110 interlocks with the base unit 113 and performs the first acquisition operation of acquiring the target object 10 based on the first pickup operation. Additionally, the handling part 110 performs the second acquisition operation of acquiring the replacement target object 20 based on the second pickup operation.

The acquisition unit 111 is positioned such that at least a portion of the acquisition unit 111 faces the pickup unit 112, enabling the first acquisition operation for the target object 10 and the second pickup operation for the replacement target object 20 to be performed. The acquisition unit 111 is relayed from the first acquisition operation to the second acquisition operation via the vertical inversion operation.

Embodiments of the present disclosure have been described above with reference to the accompanying drawings, but the present disclosure is not limited thereto and may be implemented in various different forms. It will be understood that the present disclosure can be implemented in other specific forms without changing the technical spirit or gist of the present disclosure. Therefore, it should be understood that the embodiments set forth herein are illustrative in all respects and not limiting.

What is claimed is:

1. A driving apparatus comprising:
a driving part for driving; and
a handling part positioned above the driving part and handling a target object,
wherein the handling part transports the target object to a destination and performs a self-replacement operation of replacing the target object with a replacement target object located at the destination.

2. The driving apparatus of claim 1, wherein the handling part includes a base unit and a pickup unit, which interlocks with the base unit and performs a first pickup operation of picking up the target object and a second pickup operation of picking up the replacement target object.

3. The driving apparatus of claim 2, wherein the handling part further includes an acquisition unit, which interlocks with the base unit and performs a first acquisition operation of acquiring the target object based on the first pickup operation and a second acquisition operation of acquiring the replacement target object based on the second pickup operation.

4. The driving apparatus of claim 3, wherein
the acquisition unit is positioned such that at least a portion of the acquisition unit faces the pickup unit, enabling the first acquisition operation for the target object and the second pickup operation for the replacement target object to be performed.

5. The driving apparatus of claim 4, wherein the acquisition unit is relayed from the first acquisition operation to the second acquisition operation via a vertical inversion operation.

6. The driving apparatus of claim 5, wherein the acquisition unit includes an upper panel module, a lower panel module, which interlocks with the upper panel module and where the replacement target module is located, and an interlocking module, which enables the upper panel module to interlock with the lower panel module.

7. The driving apparatus of claim 6, wherein
a plurality of first fixing members are provided along a circumference of an upper part of the upper panel module to secure the target object at the upper panel module,
a plurality of second fixing members are provided along a circumference of a lower part of the lower panel module to secure the replacement target module at the lower panel module,
the first fixing members grasp the target object on the upper panel module using a joint rotation method or press and secure the circumference of the target object by slidably moving on the upper panel module, and
the second fixing members grasp the replacement target object on the upper panel module using a joint rotation method or press and secure the circumference of the target object by slidably moving on the lower panel module.

8. The driving apparatus of claim 7, wherein
the vertical inversion operation of the handling part includes a first vertical inversion operation, which replaces the upper panel module, where the target object is chucked, with the lower panel module at a first point in time before the departure of the driving part to the destination via a rotation method, and a second vertical inversion operation, which replaces the upper panel module, where the target object is chucked, with the lower panel module at a second point in time after the arrival of the driving part at the destination.

9. The driving apparatus of claim 8, wherein
the acquisition unit displaces the upper panel module to take the position of the lower panel module via the second vertical inversion operation after the first vertical inversion operation, and
the pickup unit performs a third pickup operation of picking up the target object from the upper panel module and positioning the target object at the destination.

10. The driving apparatus of claim 8, wherein
the first pickup operation of the pickup unit is performed first,
then the first acquisition operation of the upper panel module is performed based on the first pickup operation,
then the driving part departs to the destination, and
then the second acquisition operation of the lower panel module is performed based on the second pickup operation.

11. The driving apparatus of claim 10, wherein the pickup unit positions the replacement target object on the lower panel module that has been subjected to the first vertical inversion operation, via the second pickup operation.

12. The driving apparatus of claim 7, wherein
the target object is chucked on the upper panel module, and
the replacement target object is chucked on the lower panel module.

13. The driving apparatus of claim 1, wherein if the target object corresponds to a probe card, the destination corresponds to a probe station.

14. The driving apparatus of claim 1, wherein the driving part performs autonomous driving for an unmanned process within a cleanroom line.

15. A driving apparatus comprising:
a driving part for driving; and
a handling part positioned above the driving part and handling a target object,
wherein
the handling part transports the target object to a destination and performs a self-replacement operation of replacing the target object with a replacement target object located at the destination,
the handling part includes a base unit and a pickup unit, which interlocks with the base unit and performs a first pickup operation of picking up the target object and a second pickup operation of picking up the replacement target object,
the handling part further includes an acquisition unit, which interlocks with the base unit and performs a first acquisition operation of acquiring the target object based on the first pickup operation and a second acquisition operation of acquiring the replacement target object based on the second pickup operation, and
if the target object corresponds to a probe card, the destination corresponds to a probe station.

16. An operating method of a driving apparatus, comprising:
preparing a driving part for driving; and
handling, by a handling part, a target object based on the driving of the driving part,
wherein the handling part transports the target object to a destination and performs a self-replacement operation of replacing the target object with a replacement target object located at the destination.

17. The operating method of claim 16, wherein the handling part includes a base unit and a pickup unit, which interlocks with the base unit and performs a first pickup operation of picking up the target object and a second pickup operation of picking up the replacement target object.

18. The operating method of claim 17, wherein the handling part includes an acquisition unit, which interlocks with the base unit and performs a first acquisition operation of acquiring the target object based on the first pickup operation and a second acquisition operation of acquiring the replacement target object based on the second pickup operation.

19. The operating method of claim 18, wherein the acquisition unit is positioned such that at least a portion of the acquisition unit faces the pickup unit, enabling the first acquisition operation for the target object and the second pickup operation for the replacement target object to be performed.

20. The operating method of claim 19, wherein the acquisition unit is relayed from the first acquisition unit to the second acquisition unit via a vertical inversion operation.
